(19) United States
(12) Patent Application Publication
(10) Pub. No.: US 2025/0034308 A1
(43) Pub. Date: Jan. 30, 2025

(54) PHOTOCURABLE SILICONE RESIN COMPOSITION AND CURED PRODUCT THEREOF

(71) Applicant: NIPPON STEEL CHEMICAL & MATERIAL CO., LTD., Tokyo (JP)

(72) Inventors: Toshihiro Kawatani, Tokyo (JP); Takashi Salto, Tokyo (JP)

(73) Assignee: NIPPON STEEL CHEMICAL & MATERIAL CO., LTD., Tokyo (JP)

(21) Appl. No.: 18/716,997

(22) PCT Filed: Dec. 19, 2022
(86) PCT No.: PCT/JP2022/046749

§ 371 Date: Jun. 6, 2024

(30) Foreign Application Priority Data
Dec. 22, 2021 (JP) 2021-207874

(51) Int. Cl. C08F 283/12; C08F 2/50; C08J 7/04; C08J 7/046; C08K 3/013; C08K 5/07; C09J 4/06; C09J 151/08

(52) U.S. Cl. CPC C08F 283/124; C08F 2/50; C08J 7/0427; C08J 7/046; C08K 3/013; C08K 5/07; C09J 4/06; C09J 151/085; C08K 2201/005; C08K 2201/011

(57) ABSTRACT

The invention provides a photocurable silicone resin composition having excellent adhesion to cyclic olefin resin films and moldings, a cured film, and a laminate thereof. Provided is a photocurable silicone resin composition for use as a hard coat layer of a cyclic olefin resin film, the photocurable silicone resin comprising: 100 parts by mass of a silicone resin composition (A) prepared by blending a reactive silicone resin (A1) including, as main component, polyorganosilsesquioxane represented by the general formula (1) and having a cage-type structure in the structural unit, [RSiO_{3/2}]ₙ (1) (wherein R is an organic functional group having a (meth)acryloyl group, and n is 8, 10 or 12), and an unsaturated compound (A2) that contains at least one unsaturated group represented by —R³—CR⁴═CH₂ or —CR⁴═CH₂ in one molecule (wherein R³ represents an alkylene group, an alkylidene group, or —O—C(═O)— group, and R⁴ represents a hydrogen atom or an alkyl group).

### TECHNICAL FIELD

The present invention relates to a photocurable silicone resin composition having excellent adhesion to cyclic olefin resin films or moldings, capable of imparting excellent pencil hardness to the films or moldings, a cured film, and a laminate thereof.

In recent years, needs for good design, weight reduction, and thinning in every field including displays, mobile devices, home appliances, and automobile parts have increased. As surface protection members for such a product, plastics and some lightweight metals have been used instead of conventional glass or metals. However, plastics and some lightweight metals have low surface hardness and are easily damaged. Accordingly, a method of providing a hard coat layer for protecting the surface has been used.

Acrylic compositions have been often used for such hard coat layers. Since acrylic compositions generally form a film which is cured through a radical reaction caused by irradiation with active energy rays such as ultraviolet rays and electron beams, curing at low temperature in a short period of time can be achieved. Further, depending on the resin composition, the toughness can be maintained, so that acrylic compositions are widely used in paints and adhesives.

As an example of such a hard coat layer, the present inventors have focused attention on a reactive silicone resin having a cage-type structure and a reactive functional group, and have found that by increasing the number of reactive functional groups in the reactive silicone resin having the cage-type structure and blending the reactive silicone resin with an unsaturated compound that can be radically copolymerized with the reactive silicone resin at a specific ratio, a transparent silicone resin molding excellent in the balance among high surface hardness, heat resistance, mechanical properties and dimensional stability can be produced, and have disclosed that the silicone resin molding can be suitably used as an alternative to inorganic glass (Patent Literature 1 and 2). Further, a method for producing such a reactive silicone resin having a cage-type structure is disclosed in Patent Literature 3, in particular.

On the other hand, cyclic olefin resins have been increasingly used as optical components for mobile phones, smartphones, liquid crystal displays, lenses, etc., due to having high transparency and low hygroscopicity. Cyclic olefin resins are easily scratched due to having relatively low surface hardness. Accordingly, a hard coat layer is suitably provided. However, the adhesion between the cyclic olefin resin and the hard coat has not been necessarily sufficient. Therefore, prior to forming the hard coat layer, the surface of the cyclic olefin resin needs to be subjected to a step for easy-adhesion such as corona discharging and application of an easy-adhesion primer composition (Patent Literature 4).

Furthermore, in Patent Literature 5, a laminate of a cyclic olefin resin layer, and a layer containing a diphenyl sulfide compound, a benzophenone compound, a compound having a (meth)acryloyl group, and a compound having a silanol group and/or an alkoxysilyl group, and in Patent Literature 6, a composition containing a polyfunctional (meth)acrylate, a benzophenone compound and a polysiloxane, are proposed. However, in some cases, the hardness of the laminate and the adhesion to the cyclic olefin resin are not sufficient.

### CITATION LIST

### Patent Literature

Patent Literature 1: Japanese Patent No. 4558643
Patent Literature 2: Japanese Patent No. 5698566
Patent Literature 3: JP2004-143449 A
Patent Literature 4: Japanese Translation of PCT International Application Publication No. 2008-518280
Patent Literature 5: JP2015-127102 A
Patent Literature 6: JP2016-105164 A

### SUMMARY OF INVENTION

The problem to be solved by the present invention is to provide a photocurable silicone resin composition having excellent adhesion to cyclic olefin resin films and moldings, capable of imparting excellent pencil hardness to the films or moldings, a cured film, and a laminate thereof.

The present inventors have found that the problem can be solved by allowing the photocurable silicone resin composition to contain a polymerizable compound having a specific structure as radically copolymerizable unsaturated compound at a specific proportion, in combination with a specific photopolymerization initiator, so that the present invention has been completed.

In other words, the present invention relates to a photocurable silicone resin composition for use as a hard coat layer of a cyclic olefin resin film, the photocurable silicone resin comprising:
100 parts by mass of a silicone resin composition (A) prepared by blending
   a reactive silicone resin (A1) including, as main component, polyorganosilsesquioxane represented by a general formula (1) and having a cage-type structure in the structural unit

[RSiO_{3/2}]ₙ (1)
(wherein R is an organic functional group having a (meth)acryloyl group, and n is 8, 10 or 12), and
an unsaturated compound (A2) that contains at least one unsaturated group represented by —R³—CR⁴═CH₂ or —CR⁴═CH₂ in one molecule (wherein R³ represents an alkylene group, an alkylidene group, or —O—C(═O)— group, and R⁴ represents a hydrogen atom or an alkyl group) and that is radically copolymerizable with the silicone resin (A1), at a mass ratio of 1:99 to 99:1; and
0.1 to 20 parts by mass of a photopolymerization initiator (B);
wherein the number of moles of acrylic per 100 g of the silicone resin composition (A) is 0.8 to 1.1, 20 mass % or more of the silicone resin composition (A) is an unsaturated compound containing a hydroxy group, and a benzophenone photopolymerization initiator is used as the photopolymerization initiator (B).

According to the present invention, a photocurable silicone resin composition having excellent adhesion to cyclic olefin resin films and moldings, capable of imparting excellent pencil hardness to the films or moldings, a cured film, and a laminate thereof can be provided.

### DESCRIPTION OF EMBODIMENTS

Hereinafter, each element constituting the present invention will be described in detail. Since the following description is an example embodiment of the present invention, the present invention is not limited to the following description as long as it does not exceed the gist thereof. In addition, in the case of using an expression “to” in the present specification, the expression includes prescribed and postscribed numerical values or physical property values. In the present invention, in the case of using an expression “(meth)acrylic”, the expressing means one or both of “acrylic” and “methacrylic”. The same applies to “(meth)acrylate” and “(meth)acryloyl”.

A photocurable silicone resin composition of the present invention comprises:
a silicone resin composition (A) prepared by blending
a reactive silicone resin (A1) including, as main component, polyorganosilsesquioxane represented by a general formula (1) and having a cage-type structure in the structural unit

[RSiO_{3/2}]ₙ (1)
(wherein R is an organic functional group having a (meth)acryloyl group, and n is 8, 10 or 12), and
an unsaturated compound (A2) that contains at least one unsaturated group represented by —R³—CR⁴═CH₂ or —CR⁴—CH₂ in one molecule (wherein R³ represents an alkylene group, an alkylidene group, or —O—C(═O)— group, and R⁴ represents a hydrogen atom or an alkyl group) and that is radically copolymerizable with the silicone resin (A1), at a mass ratio of 1:99 to 99:1; and
a benzophenone photopolymerization initiator (B).

The reactive silicone resin (A1) of the silicone resin composition (A) includes, as main component, polyorganosilsesquioxane (also referred to as cage-type polyorganosilsesquioxane, and polyorganosilsesquioxane is also referred to as silsesquioxane) represented by the following general formula (1) and having a cage-type structure in the structural unit.

[RSiO_{3/2}]ₙ (1)

In the general formula (1), R is an organic functional group having a (meth)acryloyl group, and n is 8, 10 or 12.

Examples of R include groups represented by the following general formula (2):

CH₂═CR¹—COO—(CH₂)ₘ— (2)

In the formula (2), m is an integer of 1 to 3, and R¹ is a hydrogen atom or a methyl group.

Such a reactive silicone resin (A1) has an organic functional group having a (meth)acryloyl group on the silicon atom in the molecule. Specific structures of the cage-type polyorganosilsesquioxane with n of 8, 10, or 12 in the general formula (1) include a cage-type structure represented by each of the following structural formulas (3), (4), and (5). R in the following formulas represents the same as R in the general formula (1).

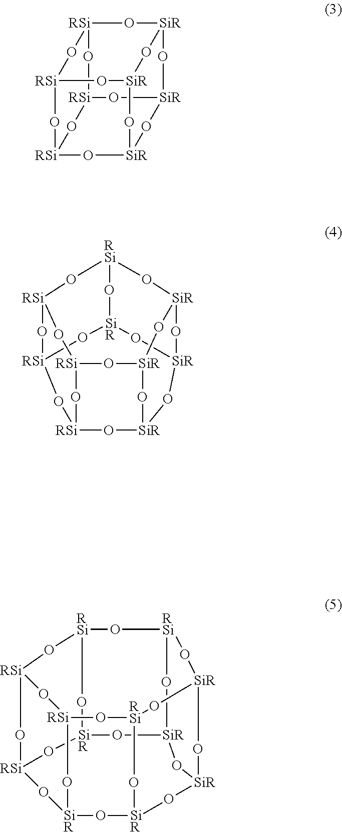

Here, such a reactive silicone resin (A1) may be produced by the method described in Patent Literature 3 and the like.

For example, the production method may include the steps of hydrolyzing and partially condensing a silicon compound represented by the general formula “RSiX₃” in the presence of a polar solvent and a basic catalyst, and further recondensing the resulting hydrolysis product in the presence of a nonpolar solvent and a basic catalyst.

Here, in the general formula “RSiX₃”, R is an organic functional group having a (meth)acryloyl group, and is common to R of the reactive silicone resin (A1) represented by the general formula (1). For example, R is a group represented by the general formula (2). Specific examples of preferable R include a 3-methacryloxypropyl group, a methacryloxymethyl group and a 3-acryloxypropyl group. X represents a hydrolyzable group.

In the silicon compound represented by the general formula “RSiX₃” for use as a raw material, the hydrolyzable group X is not particularly limited as long as it is a hydrolyzable group. Examples thereof include an alkoxyl group and an acetoxy group, and an alkoxyl group is preferred. Examples of the alkoxyl group include a methoxy group, an ethoxy group, an n- or i-propoxy group, an n-, i- or t-butoxy group. A methoxy group is preferred due to having high reactivity.

Preferred examples of the compound among the silicon compounds represented by RSiX₃ include methacryloxymethyltriethoxysilane, methacryloxymethyltrimethoxysilane, 3-methacryloxypropyltrichlorosilane, 3-methacryloxypropyltrimethoxysilane, 3-methacryloxypropyltriethoxysilane, 3-acryloxypropyltrimethoxysilane, and 3-acryloxypropyltrichlorosilane. Among them, it is preferable to use 3-methacryloxypropyltrimethoxysilane, due to easy availability of raw materials.

Examples of the basic catalyst for use in the hydrolysis reaction include alkali metal hydroxides such as potassium hydroxide, sodium hydroxide and cesium hydroxide, and ammonium hydroxide salts such as tetramethylammonium hydroxide, tetraethylammonium hydroxide, tetrabutylammonium hydroxide, benzyltrimethylammonium hydroxide and benzyltriethylammonium hydroxide. Among these, tetramethylammonium hydroxide is preferably used due to having high catalytic activity. The basic catalysts are usually used as aqueous solutions.

Regarding the hydrolysis reaction conditions, the reaction temperature is preferably 0 to 60° C., more preferably 20 to 40° C. At a reaction temperature of lower than 0° C., the reaction rate is slow and the hydrolyzable groups remain in an unreacted state, resulting in a long reaction time. On the other hand, at a temperature higher than 60° C., due to the too fast reaction rate, a complicated condensation reaction proceeds, so that the hydrolysis product tends to have a high molecular weight. Further, the reaction time is preferably 2 hours or more. With a reaction time of less than 2 hours, the hydrolysis reaction may not proceed sufficiently and the hydrolyzable groups may remain in an unreacted state.

The presence of water is essential for the hydrolysis reaction, and water may be supplied from an aqueous solution of the basic catalyst, or may be added separately. The amount of water may be at least to hydrolyze the hydrolyzable groups, preferably 1.0 to 1.5 times the theoretical amount. In addition, it is necessary to use an organic polar solvent for hydrolysis, and alcohols such as methanol, ethanol, and 2-propanol, or other organic polar solvents may be used as the organic polar solvent. Lower alcohols having 1 to 6 carbon atoms that are soluble in water are preferred, and use of 2-propanol is more preferred. Use of a non-polar solvent is not preferred, because a uniform reaction system cannot be obtained, and the hydrolysis reaction proceeds insufficiently, so that unreacted hydrolyzable groups remain.

After completion of the hydrolysis reaction, the water or water-containing reaction solvent is separated. For separation of water or the water-containing reaction solvent, means such as vacuum evaporation may be employed. In order to sufficiently remove water and other impurities, means including adding a non-polar solvent to dissolve the hydrolysis reaction product, washing the solution with saline or the like, and then drying the solution with a desiccant such as anhydrous magnesium sulfate may be employed. In the case where the non-polar solvent is separated by means such as evaporation, the hydrolysis reaction product may be recovered. However, in the case where the non-polar solvent is usable as non-polar solvent in the subsequent reaction, the separation thereof is not required.

In a hydrolysis reaction, a condensation reaction of hydrolysate occurs along with the hydrolysis. The product in hydrolysis accompanying the condensation reaction of hydrolysate is usually a colorless viscous liquid with a number average molecular weight of 1400 to 5000. The hydrolysis product becomes an oligomer having a number average molecular weight of 1400 to 3000 depending on the reaction conditions, and a majority or preferably almost all of the hydrolyzable groups X are replaced by OH groups, and further, a majority or preferably 95% or more of the OH groups are condensed. The structure of the hydrolysis products includes a plurality types of silsesquioxanes including cage-types, ladder-types, and random-types. The compounds having a cage-type structure mainly includes incomplete cage-shaped structures with a partly open cage, with a less proportion of a complete cage structure. Accordingly, the hydrolysis product obtained through the hydrolysis is heated in an organic solvent in the presence of a basic catalyst to further condense the siloxane bonds (referred to as re-condensation), so that silsesquioxane having a cage-type structure is selectively produced.

Specifically, the production is performed as follows. That is, after completion of the hydrolysis reaction as described above, water or a water-containing reaction solvent is separated, and then a recondensation reaction is performed in the presence of a nonpolar solvent and a basic catalyst. Regarding the reaction conditions for the recondensation reaction, the reaction temperature is preferably in the range of 100 to 200° C., more preferably 110 to 140° C. At a too low reaction temperature, sufficient driving force for causing the recondensation reaction cannot be obtained, so that the reaction does not proceed. At a too high reaction temperature, the (meth)acryloyl group may cause a self-polymerization reaction, so that suppression of the reaction temperature or addition of a polymerization inhibitor or the like is required. The reaction time is preferably 2 to 12 hours. The amount of the non-polar solvent used is preferably an amount sufficient to dissolve the hydrolysis reaction product, and the amount of the basic catalyst used is preferably in the range of 0.1 to 10 parts by mass (wt %) relative to the hydrolysis reaction product.

As the non-polar solvent, one having no or almost no solubility in water may be used, and hydrocarbon solvents are preferred. Such hydrocarbon solvents include non-polar solvents having a low boiling point such as toluene, benzene and xylene. Among them, toluene is preferably used. As the basic catalysts, basic catalysts used in the hydrolysis reaction may be used, and examples thereof include alkali metal hydroxides such as potassium hydroxide, sodium hydroxide, and cesium hydroxide, or ammonium hydroxide salts such as tetramethylammonium hydroxide, tetraethyl ammonium hydroxide, tetrabutylammonium hydroxide, benzyltrimethylammonium hydroxide, and benzyltriethylammonium hydroxide. Catalysts soluble in a non-polar solvent such as tetraalkylammonium are preferred.

The hydrolysis product to be used for recondensation is preferably washed with water, dehydrated and concentrated, though it may be used without washing with water and dehydration. Although water may be present during the reaction, intentional addition is not required and limiting to about a water content brought in from the basic catalyst solution is preferred. In the case where the hydrolysis products are not sufficiently hydrolyzed, water more than the theoretical amount of water required to hydrolyze the remaining hydrolyzable groups is required. However, a sufficient hydrolysis reaction is usually performed. After the recondensation reaction, the catalyst is washed away with water. Through condensation, a silsesquioxane mixture is obtained. In the resulting silsesquioxane mixture, the number of silicon atoms and the number of (meth)acryloyl groups in the molecule are preferably equal to each other.

It is considered that although the constituent components of the silsesquioxane mixture thus obtained are different depending on the reaction conditions and the state of the hydrolysis product, the constituent components include a plurality of types of cage-type silsesquioxanes in an amount of 70% or more of the total, and the remainder including ladder-type randomly cross-linked silsesquioxanes. Since separation of these is difficult and requires a lot of labor, in the case of using the cage-type silsesquioxane represented by the general formula (1) in the present invention, a silsesquioxane containing 70% or more of a plurality types of cage-type silsesquioxanes is preferably used. Incidentally, with a cage-type silsesquioxane content of 70% or more, the same effects may be obtained. The constituent components of the plurality types of cage-type silsesquioxanes include 20 to 40% of T8 represented by general formula (3), 40 to 50% of T10 represented by general formula (4), and other component T12 represented by general formula (5). T8 can be separated by leaving the silsesquioxane mixture at 20° C. or less so as to be precipitated as needle-like crystals. The content ratio of the cage-type silsesquioxane can be checked by using, for example, GPC or LC-MS.

Such a reactive silicone resin may be a mixture of T8 to T12, or may be one or two separated or concentrated therefrom such as T8, though not limited to the silicone resin obtained by the production method described above.

The reactive silicone resin (A1) is preferably blended in an amount of 1.0 to 99 parts by mass relative to 100 parts by mass of the silicone resin composition (A). An amount of 2.0 to 75 parts by mass is preferred, and an amount of 2.5 to 30 parts by mass is more preferred. A too small amount results deterioration of adhesion due to lowered reactivity. Further, the cross-linking density is also lowered, resulting in softening and deterioration in pencil hardness. An excessive amount allows the cross-linking density to increase, resulting in a hardened and brittle product which causes cracks and peeling.

The silicone resin composition (A) of the present invention contains, as main components, the reactive silicone resin (A1) together with an unsaturated compound (A2) that contains at least one unsaturated group represented by —R³—CR⁴═CH₂ or —CR⁴═CH₂ in one molecule (wherein R³ represents an alkylene group, an alkylidene group or —O—C(═O)— group, and R⁴ represents a hydrogen atom or an alkyl group) and that is copolymerizable with the silicone resin (A1). The unsaturated compound (A2) may be blended in an amount of 1.0 to 99 parts by mass relative to 100 parts by mass of the silicone resin composition (A). The amount is preferably 50 to 98 parts by mass, more preferably 60 to 97 parts by mass. Thus, excellent adhesion and pencil hardness can be achieved.

Preferably, 10 to 100 mass % of the unsaturated compound (A2) is a non-silicone-type polyfunctional unsaturated compound containing at least two unsaturated groups described above and having no silicon atoms in the molecule. By blending such a polyfunctional unsaturated compound, a laminate having a high pencil hardness can be obtained.

The proportion of the unsaturated compound containing hydroxy groups in the molecule in the silicone resin composition (A) is required to be 20 mass % or more. In the silicone resin composition (A) composed of the silicone resin (A1) and the unsaturated compound (A2), it is the blending ratio of the unsaturated compound containing a hydroxy group in the molecule in the component A2. The unsaturated compounds having a hydroxy group in the molecule can improve reactivity due to a shortened distance between molecules resulting from the interaction of hydroxy groups. Further, the generated radicals quickly react with double bonds to improve the curing speed, so that the adhesion to the cyclic olefin resin is improved. In addition, since radical polymerization proceeds prior to the reaction between oxygen and radicals, inhibition of curing by oxygen can be suppressed. In the case where the proportion of the unsaturated compound containing a hydroxy group in the molecule is too small in the unsaturated compound (A2), the effect of intermolecular interaction is weakened. Preferably, it is 25 mass % or more. On the other hand, although there exists no particular upper limit for the blending, excessive increase in the proportion results in almost no improvement in reactivity and no increase in the effect of suppressing inhibition by oxygen. Therefore, the sufficient proportion of the unsaturated compound containing a hydroxy group in the molecule in the silicone resin composition (A) is 50 mass % or less, or even 40 mass % or less.

Among the unsaturated compounds (A2), examples of those containing a hydroxy group in the molecule include pentaerythritol triacrylate, glycerol dimethacrylate, dipentaerythritol pentaacrylate, dipentaerythritol tetraacrylate, and 2-hydroxy-3-acryloyloxy propyl methacrylate.

On the other hand, examples of the unsaturated compounds containing no hydroxy group in the molecule include trimethylolpropane triacrylate, pentaerythritol tetraacrylate, dipentaerythritol hexaacrylate, dimethylol tricyclodecane diacrylate, 1,6-hexanediol diacrylate, and 1,9-nonanediol diacrylate. In addition to these, compounds with all the terminal hydroxy groups of the skeleton modified with unsaturated groups obtained by modifying all the hydroxy groups of pentaerythritol and dipentaerythritol with glycols such as ethylene and isopropylene, or γ-butyrolactone, etc., may be used. Alternatively, examples thereof include urethane acrylates and acrylic copolymer acrylates. These unsaturated compounds containing a hydroxy group in the molecule or unsaturated compounds containing no hydroxy group may be used either singly or in combination of two or more, respectively.

The silicone resin composition (A) may have a number of moles of acrylic per 100 g in the range of 0.80 to 1.10, preferably 0.85 to 1.05, and more preferably 0.90 to 1.03. In the case where the number of moles of acrylic is too small, the cross-linking density may decrease and the pencil hardness may be lowered. On the other hand, in the case where the number of moles of acrylic is too large, cracks may occur due to excessive stress resulting from shrinkage during curing, which may cause a poor appearance.

The number of moles of acrylic per 100 g represents the sum of the number of moles of acrylic of each component (number of acrylic functional groups/molecular weight g·mol⁻¹) per 100 g of silicone resin composition (A) as a photopolymerizable compound.

In the present specification, a compound prepared by blending the silicone resin (A1) and the unsaturated compound (A2) is referred to as silicone resin composition (A). A compound including the silicone resin composition (A) to which a photopolymerization initiator (B) to be described below and, on an as needed basis, other additives are blended is referred to as a photocurable silicone resin composition of the present invention. Regarding the method of blending, the silicone resin (A1), the unsaturated compound (A2) may be blended first, or the silicone resin (A1), the unsaturated compound (A2) and the photopolymerization initiator (B) may be blended at the same time. In other words, the order of blending is optional. As described below, the photocurable silicone resin composition of the present invention may contain various additives, and the order of blending these additives is also optional.

The photocurable silicone resin composition of the present invention contains a benzophenone-based photopolymerization initiator as the photopolymerization initiator (B), which is an essential component. The benzophenone-based photopolymerization initiator is not particularly limited as long as it is a compound having two benzene rings linked through a carbonyl group, though ones in the following are preferred. By containing the benzophenone-based photopolymerization initiator, the photocurable silicone resin composition of the present invention produces a cured film particularly excellent in adhesion to a cyclic olefin resin.

Examples of the benzophenone-based photopolymerization initiators (B) include benzophenone, alkyl-substituted benzophenones such as 4-methylbenzophenone and 4,4′-dimethylbenzophenone; alkenyl-substituted benzophenones such as 4-allylbenzophenone and 4-vinylbenzophenone; alkoxy-substituted benzophenones such as 2-methoxybenzophenone and 4,4′-dimethoxybenzophenone; hydroxy-substituted benzophenones such as 4,4′-dihydroxybenzophenone, 2,4′-dihydroxybenzophenone, and 3,3′-dimethyl-dihydroxybenzophenone; alkyl keto-substituted benzophenones such as 4-acetobenzophenone; alkylthio-substituted benzophenones or alkenylthio-substituted benzophenones such as 4,4′-divinylthiobenzophenone and 4-methylthiobenzophenone; arylthio-substituted benzophenones such as [4-(methylphenylthio)phenyl]-phenylmethane; and ester-substituted benzophenones such as 4,4′-diacetoxybenzophenone, and 4,4′-dimethacryloyloxy benzophenone.

These benzophenone-based photopolymerization initiators may be used alone or in combination of two or more.

The photopolymerization initiator (B) may be blended in an amount of 0.1 to 20 parts by mass, preferably in the range of 0.5 to 10 parts by mass, more preferably in the range of 1.0 to 8 parts by mass, relative to 100 parts by mass of the silicone resin composition (A). In the case where the content is less than the range, due to insufficient cross-linking, the adhesion is lowered and the elastic modulus is also lowered, so that a desired pencil hardness may not be obtained. On the other hand, in the case where the content exceeds the range, the transmittance of the photocurable silicone resin composition is lowered, so that the supply of light to the interface between the photocurable silicone resin composition and the cyclic olefin resin is hindered. As a result, the cross-linking proceeds insufficiently, so that the adhesion is lowered.

In the case where the photocurable resin composition is used as the hard coat layer of a cyclic polyolefin resin film, the film thickness (after drying) of the photocurable resin composition after application to the film surface is preferably 0.5 μm to 15 μm, more preferably 1 to 13 μm, and still more preferably 3 to 12 μm. With a thickness of less than 0.5 μm, the desired pencil hardness cannot be obtained, and with a thickness of more than 15 μm, though the pencil hardness is improved, the supply of light to the interface between the photocurable silicone resin composition and the cyclic olefin resin is hindered, so that cross-linking proceeds insufficiently, resulting in lowering of the adhesion.

The photopolymerization initiator (B) may be used in combination with another photopolymerization initiator as long as it does not interfere with the absorption wavelength of the benzophenone-based photopolymerization initiator. In the case where the absorption wavelengths overlap, adhesion to the cyclic olefin resin may be lowered. Even in the case where another photopolymerization initiator is used in combination, the amount of the other photopolymerization initiator blended is preferably 30 mass % or less, more preferably 10 mass % or less, relative to the total amount of the photopolymerization initiator (B).

Examples of the other photopolymerization initiators include benzoin compounds such as benzoin, benzoin methyl ether, benzoin ethyl ether, benzoin propyl ether, and benzoin isobutyl ether; acetophenone compounds such as acetophenone, 2,2-diethoxy-2-phenylacetophenone, 2,2-diethoxy-2-phenylacetophenone, 1,1-dichloroacetophenone, 2-hydroxy-2-methyl-phenylpropan-1-one, diethoxyacetophenone, 1-hydroxycyclohexylphenyl ketone, and 2-methyl-1-[4-(methylthio)phenyl]-2-morpholinopropan-1-one; anthraquinones such as 2-ethylanthraquinone, 2-tert-butylanthraquinone, 2-chloroanthraquinone and 2-amylanthraquinone; thioxanthones such as 2,4-diethylthioxanthone, 2-isopropylthioxanthone and 2-chlorothioxanthone; ketals such as acetophenone dimethyl ketal and benzyl dimethyl ketal; and phosphine oxides such as 2,4,6-trimethylbenzoyl diphenylphosphine oxide, and bis(2,4,6-trimethylbenzoyl)-phenylphosphine oxide. Furthermore, the photopolymerization initiators may be used in combination with photoinitiation aids including tertiary amines such as triethanolamine and methyldiethanolamine, and benzoic acid derivatives such as N, N-dimethylaminobenzoic acid ethyl ester and N, N-dimethylaminobenzoic acid isoamyl ester.

The photocurable silicone resin composition of the present invention may be blended with an inorganic filler (C). The inorganic filler (C) is not particularly limited, and preferred examples thereof include the following inorganic oxide fine particles and inorganic halide fine particles. Addition of inorganic particles allows the pencil hardness of the cured film or laminate of the photocurable silicone resin composition to be further increased.

Examples of the inorganic filler (C) include oxides of silicon, aluminum, zirconium, titanium, zinc, lead, germanium, indium, tin, antimony, cerium and lithium, or composite oxides thereof, and specific examples thereof include oxide of silicon (silica), oxide of aluminum (alumina), silicon-aluminum composite oxide, oxide of zirconium (zirconia), oxide of titanium (titania), zinc oxide, tin oxide, phosphorus-doped tin oxide (PTO), antimony-doped tin oxide, indium-tin composite oxide (ITO), cerium oxide, and silica-lithium oxide composite oxide. Examples of the inorganic halide fine particles include alkali metal halides such as lithium chloride, sodium fluoride and potassium bromide; and alkaline earth metal halides such as calcium fluoride and magnesium chloride.

The inorganic filler (C) has an average primary particle size of 1 to 100 nm. From the viewpoint of improving the pencil hardness of the cured film, it is advantageous to use one having a relatively large average primary particle size. However, from the viewpoint of compatibility between pencil hardness and transparency, it is preferable that the average primary particle size is within the range of 5 nm to 100 nm. With an average primary particle size of less than 1 nm, the effect of improving the pencil hardness of the cured film may be reduced when used in combination with other organic materials. With an average primary particle size of more than 100 nm, the transparency of the photocurable silicone resin composition may be impaired.

The inorganic filler (C) may be blended in an amount of 1 to 50 parts by mass, preferably 3 to 30 parts by mass, more preferably 5 to 20 parts by mass, relative to 100 parts by mass of the silicone resin composition (A). With a too small amount, the effect of improving the pencil hardness of the cured film is small, while with a too large amount, the flatness of the cured film deteriorates.

The laminate of the present invention has a cured film obtained by curing a photocurable silicone resin composition on at least one side of a cyclic olefin resin. The curing method includes exposing the photocurable silicone resin composition to active energy rays such as visible rays, ultraviolet rays and electron beams. The cured film is produced preferably by irradiation with ultraviolet rays with a wavelength of 10 to 400 nm or visible rays with a wavelength of 400 to 700 nm. The wavelength of the light for use is not particularly limited, and near ultraviolet rays with a wavelength of 200 to 400 nm are particularly preferably used. Examples of the lamps for use as ultraviolet light source include low-pressure mercury lamps (output: 0.4 to 4 W/cm), high pressure mercury lamps (40 to 160 W/cm), ultrahigh pressure mercury lamps (173 to 435 W/cm), and metal halide lamps (80 to 160 W/cm).

As the cyclic olefin resin, a homopolymer or a copolymer obtained by polymerizing a cyclic olefin may be used without particular limitation. Examples of commercially available cyclic olefin resins include “ZEONOR” manufactured by Zeon Corporation, “ARTON” manufactured by JSR Corporation, “TOPAS” manufactured by Polyplastics Co., Ltd., and “APEL” manufactured by Mitsui Chemicals, Inc.

The method for obtaining a cured film and a laminate by irradiation with active energy rays such as irradiation with light may be performed under any of an oxygen-blocking atmosphere and an air atmosphere. Since good cured films and laminates are obtained from the composition of the present invention even under air atmosphere, curing is preferably performed in an air atmosphere.

For example, a cured film and a laminate may be formed by applying the photocurable silicone resin composition of the present invention to a cyclic olefin resin, or diluting the photocurable silicone resin composition with various organic solvents and then applying the composition, and curing the applied composition. Specific examples of the methods include drooling, roller coating, bar coating, spray coating, air knife coating, spin coating, flow coating, curtain coating and dipping. The coating film thickness is adjusted by the solid content concentration in consideration of the film thickness to be formed after drying and curing with an ultraviolet lamp. In the case of using an organic solvent to adjust the solid content concentration, it is preferable to remove the organic solvent by drying or the like after coating. The drying temperature is set such that the substrate for use is not deformed, and the drying time is preferably 1 hour or less from the viewpoint of productivity.

Specific examples of organic solvents include known organic solvents including aromatic organic solvents such as toluene and xylene, ketone-based organic solvents such as methyl ethyl ketone and methyl isobutyl ketone, ester-based organic solvents such as ethyl acetate, n-propyl acetate, isopropyl acetate and isobutyl acetate, alcohol-based organic solvents methanol, ethanol, n-propanol, isopropanol, and n-butanol, and glycol ether-based organic solvents such as propylene glycol monomethyl ether. In particular, a glycol-based organic solvent is preferably included.

Examples of glycol ether-based organic solvents include ethylene glycol ethers such as ethylene glycol monomethyl ether, ethylene glycol monoethyl ether, ethylene glycol dimethyl ether, ethylene glycol diethyl ether, ethylene glycol n-propyl ether, ethylene glycol monoisopropyl ether, ethylene glycol dipropyl ether, ethylene glycol monobutyl ether, ethylene glycol monoisobutyl ether, ethylene glycol dibutyl ether, ethylene glycol isoamyl ether, ethylene glycol monohexyl ether, ethylene glycol mono-2-ethylhexyl ether, methoxy ethoxyethanol and ethylene glycol monoallyl ether; and propylene glycols such as propylene glycol monomethyl ether, propylene glycol monoethyl ether, propylene glycol monopropyl ether, propylene glycol monobutyl ether, and butoxy propanol. In particular, propylene glycol monomethyl ether is preferred.

The cured film or laminate (cured photocurable silicone resin) of the present invention thus obtained has good adhesion to a cyclic olefin resin film. For example, the pencil hardness (according to JIS K5600) is 2H or more, preferably 3H or more.

Various additives may be added to the photocurable silicone resin composition of the present invention without deviation from the purpose of the present invention. Examples of the various additives include plasticizers, flame retardants, heat stabilizers, antioxidants, light stabilizers, UV absorbers, leveling agents, slipping agents, antistatic agents, release agents, foaming agents, nucleating agents, coloring agents, fluorescent whitening agents, cross-linking agents, dispersing aids, and resin components.

### EXAMPLE

Examples of the present invention are shown below. The reactive silicone resin (A1) for use in the Examples described below was obtained by the method shown in the Synthesis Example described below.

### Synthesis Example 1

A reaction vessel equipped with a stirrer, a dropping funnel and a thermometer was charged with 40 ml of 2-propanol (IPA) as solvent and 5% tetramethylammonium hydroxide aqueous solution (TMAH aqueous solution) as basic catalyst. The dropping funnel was charged with 15 ml of IPA and 12.69 g of 3-methacryloxypropyl trimethoxysilane (structural formula shown below; manufactured by Dow Toray Co., Ltd., XIAMETER, OFS-6030 Silane).

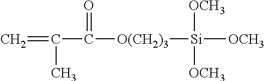

While stirring the reaction vessel, the IPA solution of MTMS was added dropwise at room temperature over 30 minutes. After completion of the dropwise addition of MTMS, the mixture was stirred for 2 hours without heating. After stirring for 2 hours, the solvent was removed under reduced pressure and the solute was dissolved into 50 ml of toluene. The reaction solution was washed with saturated saline to be neutralized, and then dehydrated with anhydrous magnesium sulfate. The anhydrous magnesium sulfate was filtered off and 25.8 g of a hydrolysis product (silsesquioxane) was obtained through concentration. The silsesquioxane was a colorless viscous liquid soluble in various organic solvents.

Next, the resulting 20.65 g of silsesquioxane, 82 ml of toluene, and 3.0 g of 10% TMAH aqueous solution were placed in a reaction vessel equipped with a stirrer, a Dean-Stark apparatus, and a condenser, and the mixture was gradually heated so that water was distill off. Further, the mixture was heated to 130° C., and the recondensation reaction was performed at the reflux temperature of toluene. The temperature of the reaction solution at the time was 108° C. After refluxing toluene, stirring was performed for 2 hours, and then the reaction was terminated. The reaction solution was washed with saturated saline to be neutralized, and then dehydrated with anhydrous magnesium sulfate. The anhydrous magnesium sulfate was filtered off, and 18.77 g of a desired cage-type silsesquioxane (mixture) was obtained through concentration. The resulting cage-type silsesquioxane (A1-1) was a colorless viscous liquid soluble in various organic solvents.

Through mass spectrometry of the reaction product of recondensation reaction after liquid chromatography separation, molecular ions having ammonium ions attached to the molecular structures (3), (4) and (5) with R representing a methacryloyl group were identified, and the composition ratio T8:T10:T12:others was about 2:4:1:3, so that a silicone resin having a cage structure as main component was identified. Note that T8, T10 and T12 correspond to formulas (3), (4) and (5) with R representing a methacryloyl group, respectively.

### Example 1

A photocurable silicone resin composition (A) was obtained by mixing 25 parts by mass of a cage-type silicone resin (A1-1) having the methacryloyl groups in Synthesis Example 1 on all silicon atoms as the reactive silicone resin (A1) component (Mw in terms of T8=1209.28, number of acrylic groups=8, number of hydroxy groups=0), 75 parts by mass of a mixture (A2-1) (manufactured by Nippon Kayaku Co., Ltd., product name KAYARAD DPHA) of dipentaerythritol hexaacrylate (Mw=578.57, number of acrylic groups=6, number of hydroxy groups=0) and dipentaerythritol pentaacrylate (Mw=524.52, number of acrylic groups=5, number of hydroxy groups=1) at a mass ratio of 65:35, and 1.5 parts by mass of [4-(methylphenylthio)phenyl]phenylmethane (B-1) (manufactured by Double Bond Chemical Ind. Co., Ltd., trade name: BMS).

The resulting silicone resin composition (A) had a number of moles of acrylic per 100 g of [100×(8/1209.28)×0.25]+{[(100×6/578.57×0.65)+(100×5/524.5 2×0.35)]×0.75}=0.92, and a proportion of the compounds having hydroxy groups in the molecule in the unsaturated compounds (A2) of 0.75×0.35=26 parts by mass %.

Next, 40 parts by mass of the resulting photocurable silicone resin composition, 60 parts by mass of propylene glycol monomethyl ether as diluent solvent, and 0.5 parts by mass of acrylic surface conditioner (manufactured by BYK Chemie, trade name BYK3440) were mixed. The mixture was applied to one side of a cycloolefin copolymer resin (thickness: 3 mm, length: 65 mm, width: 35 mm; trade name: APEL5014 manufactured by Mitsui Chemicals, Inc.) in the atmosphere with a spin coater to have a film thickness of 10 μm after drying and dried at 80° C. for 5 minutes. Then, the film was cured at an accumulated amount of light of 8400 mJ/cm², so that a laminate test piece having a cured film of the photocurable silicone resin on the surface of the cycloolefin copolymer resin was produced.

### Examples 2 to 11, and Comparative Examples 1 to 4

Photocurable silicone resin compositions were obtained in the same manner as in Example 1, except that the raw materials and composition ratios shown in Tables 1 and 2 were employed. Other abbreviations in the tables are as follows.

### (A2) Unsaturated Compound

A2-1: a mixture of dipentaerythritol hexaacrylate (Mw=578.57, number of acrylic groups=6, number of hydroxy groups=0) and dipentaerythritol pentaacrylate (Mw=524.52, number of acrylic groups=5, number of hydroxy groups=1) at a mass ratio of 65:35 (product name: KAYARAD DPHA, manufactured by Nippon Kayaku Co., Ltd.)

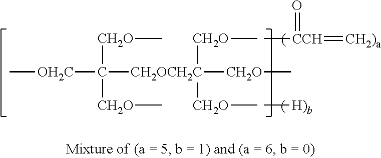

A2-2: a mixture of pentaerythritol tetraacrylate (Mw=352.34, number of acrylic groups=4, number of hydroxy groups=0) and pentaerythritol triacrylate (MW=298.29, number of acrylic groups=3, number of hydroxy groups=1) at a mass ratio of 40:60 (trade name: Light Acrylate PE-3A, manufactured by Kyoeisha Chemical Co., Ltd.)

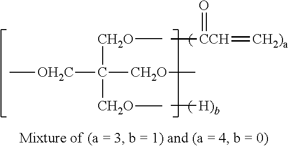

A2-3:2-hydroxy-3-acryloyloxypropyl methacrylate (Mw=214.22, number of acrylic groups=2, number of hydroxy groups=1, trade name: Light Ester G-201P, manufactured by Kyoeisha Chemical Co., Ltd.)

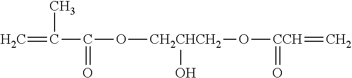

A2-4: pentaerythritol tetraacrylate (Mw=352.34, number of acrylic groups=4, number of hydroxy groups=0, manufactured by Kyoeisha Chemical Co., Ltd., trade name: Light Acrylate PE-4A)
A2-5: trimethylolpropane triacrylate (Mw=296.32, number of acrylic groups=3, number of hydroxy groups=0, manufactured by Kyoeisha Chemical Co., Ltd., trade name: Light Acrylate TMP-A)
A2-6:8-caprolactone-modified dipentaerythritol acrylate (Mw=1948.30, number of acrylic groups=6, number of hydroxy groups=0, manufactured by Nippon Kayaku Co., Ltd., trade name: DPCA-120)
A2-7: dimethylol tricyclodecane diacrylate (Mw=304.39, number of acrylic groups=2, number of hydroxy groups=0, manufactured by Kyoeisha Chemical Co., Ltd., trade name: Light Acrylate DCP-A)
A2-8: urethane acrylate oligomer (Mw=7200, number of acrylic groups=2, number of hydroxy groups=0, manufactured by Kyoeisha Chemical Co. Ltd., trade name: UF-503)

### (B) Photopolymerization Initiator

B-1: [4-(methylphenylthio)phenyl]-phenylmethane (manufactured by Double Bond Chemical Ind. Co. Ltd., trade name: BMS)

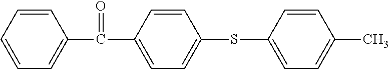 [SMILES: Cc1ccc(Sc2ccc(C(=O)c3ccccc3)cc2)cc1]

B-2: benzophenone (manufactured by Double Bond Chemical Ind. Co., Ltd., trade name BP)

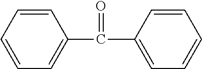 [SMILES: O=C(c1ccccc1)c1ccccc1]

B-3:2-methyl-4′-methylthio-2-morpholinopropiophenone (manufactured by IGM Resins B.V., trade name: Omnirad 907)

### (C) Inorganic Filler

C-1: Alumina (20 nm×20 nm plate-shaped, manufactured by Kawaken Fine Chemicals Co., Ltd., trade name: Organo Alumina Sol)

### [Evaluation]

The laminate test pieces obtained above were subjected to the following evaluation. The evaluation results are shown in Table 1 and Table 2.

### [Adhesion]

On the cured film surface of each laminate test piece, 100 squares of 1 mm×1 mm were made according to JIS K 5600 May 6 (1990), and an adhesive tape was attached to the surface. The adhesive tape was then peeled off rapidly to examine the remaining state of squares after the rapid peeling off, and the adhesion was evaluated based on the following criteria.
Good: The number of remaining squares is 100.
Not good: The number of remaining squares is 90 to 99.
Poor: The number of remaining squares is 0 to 89.

### [Pencil Hardness]

According to JIS K 5600, the cured film surface of each of the laminate test pieces was scratched with a Mitsubishi pencil Uni at an angle of 45 degrees under a load of 750 g, and the scratch-free hardness was determined visually.

TABLE 1

| | | | Example | Example | Example | Example | Example | Example |
|---|---|---|---|---|---|---|---|---|
| | | | 1 | 2 | 3 | 4 | 5 | 6 |
| Photocurable | Silicone resin (A1) | A1-1 | 25 | 3 | 25 | 25 | 3 | 3 |
| silicone resin | Unsaturated | A2-1 | 75 | 97 | 75 | 30 | 60 | 60 |
| composition | compound (A2) | A2-2 | | | | 45 | 27 | 22 |
| | | A2-3 | | | | | | |
| | | A2-4 | | | | | | |
| | | A2-5 | | | | | | |
| | | A2-6 | | | | | | |
| | | A2-7 | | | | | 7.5 | 7.5 |
| | | A2-8 | | | | | 2.5 | 7.5 |
| | Photopolymerization | B-1 | 1.5 | 1.5 | 7.5 | | 1.5 | |
| | initiator (B) | B-2 | | | | 1.5 | | 7.5 |
| | | B-3 | | | | | | |
| | Inorganic filler (C) | C-1 | | | | | | |

| | | | | | | |
|---|---|---|---|---|---|---|
| Number of moles of acrylic | 0.92 | 1.00 | 0.92 | 0.94 | 0.96 | 0.91 |
| Proportion of unsaturated compound | 26 | 34 | 26 | 38 | 37 | 34 |
| containing hydroxy group | | | | | | |
| Film thickness μm | 10 | 10 | 10 | 10 | 10 | 10 |
| Pencil hardness | 2 H | 2 H | 2 H | 2 H | 2 H | 2 H |
| Adhesion | Good | Good | Good | Good | Good | Good |

| | | | Example | Example | Example | Example | Example |
|---|---|---|---|---|---|---|---|
| | | | 7 | 8 | 9 | 10 | 11 |
| Photocurable | Silicone resin (A1) | A1-1 | 10 | 3 | 25 | 2.4 | 25 |
| silicone resin | Unsaturated | A2-1 | 40 | 97 | 75 | 77.6 | 75 |
| composition | compound (A2) | A2-2 | 20 | | | | |
| | | A2-3 | | | | | |
| | | A2-4 | | | | | |
| | | A2-5 | | | | | |
| | | A2-6 | | | | 20 | |
| | | A2-7 | 22.5 | | | | |
| | | A2-8 | 7.5 | | | | |
| | Photopolymerization | B-1 | 1.5 | 1 | 1.5 | 1.5 | 1.5 |
| | initiator (B) | B-2 | | | | | |
| | | B-3 | | 0.3 | | | |
| | Inorganic filler (C) | C-1 | | | 20 | 20 | |

| | | | | | |
|---|---|---|---|---|---|
| Number of moles of acrylic | 0.83 | 1.00 | 0.92 | 0.86 | 0.92 |
| Proportion of unsaturated compound | 26 | 34 | 26 | 27 | 26 |
| containing hydroxy group | | | | | |
| Film thickness μm | 10 | 10 | 10 | 10 | 17 |
| Pencil hardness | 2 H | 2 H | 3 H | 3 H | 3 H |
| Adhesion | Good | Good | Good | Good | Not good |

TABLE 2

| | | | Comparative | Comparative | Comparative | Comparative |
|---|---|---|---|---|---|---|
| | | | Example 1 | Example 2 | Example 3 | Example 4 |
| Photocurable | Silicone resin (A1) | A1-1 | | 10 | 10 | 3 |
| silicone resin | Unsaturated | A2-1 | 40 | 20 | | 97 |
| composition | compound (A2) | A2-2 | 20 | | | |
| | | A2-3 | | 20 | | |
| | | A2-4 | | | 50 | |
| | | A2-5 | | | 40 | |
| | | A2-6 | | 10 | | |
| | | A2-7 | 30 | 40 | | |
| | | A2-8 | 10 | | | |
| | Photopolymerization | B-1 | 1.5 | 1.5 | 1.5 | |
| | initiator (B) | B-2 | | | | |
| | | B-3 | | | | 1.5 |
| | Inorganic filler (C) | C-1 | | | | |

| | | | | |
|---|---|---|---|---|
| Number of moles of acrylic | 0.81 | 0.75 | 1.04 | 1.00 |
| Proportion of unsaturated compound | 26 | 27 | 0 | 34 |
| containing hydroxy group | | | | |
| Film thickness μm | 10 | 10 | 10 | 10 |
| Pencil hardness | F | B | F | H |
| Adhesion | Good | Not good | Not good | Poor |

### INDUSTRIAL APPLICABILITY

The photocurable silicone resin composition of the present invention is useful as a surface protective member (hard coat material) for plastics and lightweight metals in various fields such as displays, mobile devices, home electric appliances, and automobile parts.

1. A photocurable silicone resin composition for use as a hard coat layer of a cyclic olefin resin film, the photocurable silicone resin comprising:
100 parts by mass of a silicone resin composition (A) prepared by blending
a reactive silicone resin (A1) including, as main component, polyorganosilsesquioxane represented by a general formula (1) and having a cage-type structure in the structural unit
[RSiO_{3/2}]ₙ (1)
wherein R is an organic functional group having a (meth)acryloyl group, and n is 8, 10 or 12, and
an unsaturated compound (A2) that contains at least one unsaturated group represented by —R³—CR⁴═CH₂ or —CR⁴═CH₂ in one molecule, wherein R³ represents an alkylene group, an alkylidene group, or —O—C(═O)— group, and R⁴ represents a hydrogen atom or an alkyl group, and that is radically copolymerizable with the silicone resin (A1), at a mass ratio of 1:99 to 99:1; and
0.1 to 20 parts by mass of a photopolymerization initiator (B);
wherein the number of moles of acrylic per 100 g of the silicone resin composition (A) is 0.8 to 1.1, 20 mass % or more of the silicone resin composition (A) is an unsaturated compound containing a hydroxy group, and a benzophenone photopolymerization initiator is used as the photopolymerization initiator (B).

2. The photocurable silicone resin composition according to claim 1, wherein 10 to 100 mass % of the unsaturated compound (A2) is a non-silicone-type polyfunctional unsaturated compound containing at least two unsaturated groups represented by —R³—CR⁴═CH₂ or —CR⁴═CH₂ in one molecule.

3. The photocurable silicone resin composition according to claim 1, further comprising an inorganic filler (C) having a primary particle size of 1 to 100 nm in an amount of 1 to 50 parts by mass relative to 100 parts by mass of the silicone resin composition (A).

4. A cured product obtained by applying the photocurable silicone resin composition according to claim 1 on a cyclic olefin resin film or molding, and radically copolymerizing the composition through irradiation with active energy rays.

5. A cured product obtained by applying the photocurable silicone resin composition according to claim 2 on a cyclic olefin resin film or molding, and radically copolymerizing the composition through irradiation with active energy rays.

6. A cured product obtained by applying the photocurable silicone resin composition according to claim 3 on a cyclic olefin resin film or molding, and radically copolymerizing the composition through irradiation with active energy rays.
